(19) United States
(12) Patent Application Publication
(10) Pub. No.: US 2020/0158522 A1
(43) Pub. Date: May 21, 2020

(54) SYSTEMS AND METHODS FOR DETERMINING A NEW ROUTE IN A MAP

(71) Applicant: BEIJING DIDI INFINITY TECHNOLOGY AND DEVELOPMENT CO., LTD., Beijing (CN)

(72) Inventors: Yu WANG, Beijing (CN); Zhou YE, Beijing (CN); Duokun ZHANG, Beijing (CN); Min LI, Beijing (CN); Hui LEI, Beijing (CN); Rui GUO, Beijing (CN)

(73) Assignee: BEIJING DIDI INFINITY TECHNOLOGY AND DEVELOPMENT CO., LTD., Beijing (CN)

(21) Appl. No.: 16/748,771

(22) Filed: Jan. 21, 2020

Related U.S. Application Data
(63) Continuation of application No. PCT/CN2018/096405, filed on Jul. 20, 2018.

(30) Foreign Application Priority Data
Jul. 21, 2017 (CN) 201710599510.9

(51) Int. Cl. G01C 21/34; G01C 21/16; G01C 21/14; G01C 21/36

(52) U.S. Cl. CPC G01C 21/3415; G01C 21/3667; G01C 21/14; G01C 21/16

(57) ABSTRACT

A method for determining a new route in a map may include obtaining a plurality of original motion sequences. Each of the plurality of original motion sequences may include a departure location and a destination. The method may also include obtaining current route map information corresponding to the plurality of original motion sequences. The method may also include determining, from the plurality of original motion sequences, one or more candidate motion sequences, which have a same departure location and a same destination but being different from the current route map information. The method may also include determining a new route between the same departure location and the same destination based on the one or more candidate motion sequences.

### CROSS-REFERENCE TO RELATED APPLICATIONS

This application is a continuation of International Application No. PCT/CN2018/096405, filed on Jul. 20, 2018, which claims priority of Chinese Patent Application No. 201710599510.9 filed on Jul. 21, 2017, the entire contents of each of which are hereby incorporated by reference.

### TECHNICAL FIELD

The present disclosure generally relates to Internet technology, and in particular, relates to systems and methods for determining a new route in a map.

### BACKGROUND

In a map service, after a user inputs a departure location and a destination through an electronic device (e.g., a smart phone), a server associated with the map service may recommend a route for the user according to existing routes included in a map associated with the map service. However, since some new routes are not included in the map, the route recommended to the user may not be the optimal route and the user's travel efficiency may be compromised. At present, a map service provider may obtain information related to new expressways from municipal administration. For other new roads, the map service provider may use map collection vehicles travelling along the new roads to obtain information related to the new roads. However, this method for obtaining information related to new roads is costly and time consuming. Therefore, it is desirable to provide systems and methods for determining a new route in a map efficiently.

### SUMMARY

According to a first aspect of the present disclosure, a system for determining a new route in a map may include one or more storage media and one or more processors configured to communicate with the one or more storage media. The one or more storage media may include a set of instructions. When the one or more processors executing the set of instructions, the one or more processors may be directed to perform one or more of the following operations. The one or more processors may obtain a plurality of original motion sequences. Each of the plurality of original motion sequences may include a departure location and a destination. The one or more processors may obtain current route map information corresponding to the plurality of original motion sequences. The one or more processors may determine, from the plurality of original motion sequences, one or more candidate motion sequences, which have a same departure location and a same destination but being different from the current route map information. The one or more processors may determine a new route between the same departure location and the same destination based on the one or more candidate motion sequences.

In some embodiments, if the one or more candidate motion sequences are a multiple of candidate motion sequences, to determine the new route between the same departure location and the same destination based on the one or more candidate motion sequences, for each of the multiple of candidate motion sequences, the one or more processors may determine an overlapping degree between the each of the multiple of candidate motion sequences and remaining of the multiple of candidate motion sequences. The one or more processors may determine, as an effective motion sequence, any one of the multiple of candidate motion sequences having the overlapping degree larger than or equal to an overlapping threshold. The one or more processors may determine the new route between the same departure location and same destination based on the effective motion sequence.

In some embodiments, if there are a multiple of effective motion sequences, to determine the new route between the same departure location and the same destination based on the one or more candidate motion sequences, the one or more processors may determine a target motion sequence based on the multiple of effective motion sequences. The one or more processors may determine the new route between the same departure location and same destination based on the target motion sequence.

In some embodiments, to determine, for each of the multiple of candidate motion sequences, the overlapping degree between the each of multiple of candidate motion sequences and the remaining of the multiple of candidate motion sequences, the one or more processors may determine one or more geographic lines, corresponding to the multiple of candidate motion sequences, wherein each of the one or more geographic lines has a first geographic coordinate. The one or more processors may determine intersections between the multiple of candidate motion sequences and the one or more first geographic lines, wherein the intersection has the first geographic coordinate and a second geographic coordinate. The one or more processors may determine a difference, on each of the one or more geographic lines, between the second geographic coordinates of any one of the multiple of candidate motion sequences and remaining of the multiple of candidate motion sequences. The one or more processors may determine, corresponding to the difference, a matching degree, a sum of which is the overlapping degree.

In some embodiments, to determine, for each of the multiple of candidate motion sequences, the overlapping degree between the each of multiple of candidate motion sequences and the remaining of the multiple of candidate motion sequences, the one or more processors may designate the matching degree as 1 in response to the difference equal to or less than a difference threshold, otherwise as 0.

In some embodiments, a speed relating to each of the one or more candidate motion sequences may be greater than a speed threshold.

In some embodiments, the one or more processors may correct an address corresponding to the departure locations and/or the destinations before the one or more candidate motion sequences are determined.

In some embodiments, the one or more processors may obtain one or more original route names. The one or more processors may determine one or more candidate route names from the one or more original route names, wherein the one or more candidate route names are different from any route name included in the current route map information. The one or more processors may determine a target route name for the new route from the one or more candidate route names. The one or more processors may add the target route name to the current route map information.

In some embodiments, each of the plurality of original motion sequences may include data points each of which is associated with a location of a user at a time point.

In some embodiments, the current route map information may include locations and names of a plurality of routes in a map.

According to another aspect of the present disclosure, a method for determining a new route in a map may include one or more of the following operations. One or more processors may obtain a plurality of original motion sequences. Each of the plurality of original motion sequences may include a departure location and a destination. The one or more processors may obtain current route map information corresponding to the plurality of original motion sequences. The one or more processors may determine, from the plurality of original motion sequences, one or more candidate motion sequences, which have a same departure location and a same destination but being different from the current route map information. The one or more processors may determine a new route between the same departure location and the same destination based on the one or more candidate motion sequences.

According to yet another aspect of the present disclosure, a system for determining a new route in a map may comprise a first determination module configured to obtain a plurality of original motion sequences. Each of the plurality of original motion sequences may include a departure location and a destination. The first determination module may be also configured to obtain current route map information corresponding to the plurality of original motion sequences. The first determination module may be also configured to determine, from the plurality of original motion sequences, one or more candidate motion sequences, which have a same departure location and a same destination but being different from the current route map information. The system may also comprise a generation module configured to determine a new route between the same departure location and the same destination based on the one or more candidate motion sequences.

According to yet another aspect of the present disclosure, a non-transitory computer readable medium may comprise at least one set of instructions for determining a new route in a map. The at least one set of instructions may be executed by one or more processors of a computer server. The one or more processors may obtain a plurality of original motion sequences. Each of the plurality of original motion sequences may include a departure location and a destination. The one or more processors may obtain current route map information corresponding to the plurality of original motion sequences. The one or more processors may determine, from the plurality of original motion sequences, one or more candidate motion sequences, which have a same departure location and a same destination but being different from the current route map information. The one or more processors may determine a new route between the same departure location and the same destination based on the one or more candidate motion sequences.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary map service system according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device according to some embodiments of the present disclosure;

FIG. 4A is a block diagram illustrating an exemplary processing engine according to some embodiments of the present disclosure;

FIG. 4B is a block diagram illustrating an exemplary processing engine according to some embodiments of the present disclosure;

FIG. 5 is a flowchart illustrating an exemplary process for determining a new route in a map according to some embodiments of the present disclosure;

FIG. 6 is a flowchart illustrating an exemplary process for determining a new route according to some embodiments of the present disclosure;

FIG. 7A is a schematic diagram of determining an overlapping degree corresponding to an exemplary candidate motion sequence according to some embodiments of the present disclosure;

FIG. 7B is a schematic diagram of determining effective motion sequences according to some embodiments of the present disclosure; and

FIG. 8 is a flowchart illustrating an exemplary process for determining a target route name according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, the systems and methods in the present disclosure may be applied to any application scenario in which a map is required. For example, the system or method of the present disclosure may be applied to different transportation systems including land, ocean, aerospace, or the like, or any combination thereof. The transportation system may provide transportation services of taking a subject from one location to another location using a vehicle. The subject may include passengers and/or goods. The vehicle of the transportation service may include a taxi, a private car, a hitch, a bus, a train, a bullet train, a high speed rail, a subway, a vessel, an aircraft, a spaceship, a hot-air balloon, a driverless vehicle, a bicycle, a tricycle, a motorcycle, or the like, or any combination thereof. The transportation service may include a taxi hailing service, a chauffeur service, a delivery service, a carpooling service, a bus service, a take-out service, a driver hiring service, a shuttle service, a travel service, or the like, or any combination thereof. As another example, the system or method of the present disclosure may be applied to a navigation service, a shopping service, a house service, a location based service (LBS), or the like, or any combination thereof. The application scenarios of the system or method of the present disclosure may include a web page, a plug-in of a browser, a client terminal, a custom system, an internal analysis system, an artificial intelligence robot, or the like, or any combination thereof.

An aspect of the present disclosure relates to systems and methods for determining a new route in a map. A server of a map service system may obtain a plurality of candidate motion sequences, each of which represent a movement track of a user associated with the map service system. The plurality of candidate motion sequences have a same departure location and a same destination, and different from any existing route included in a map associated with the map service system. The server may determine an overlapping degree between each candidate motion sequence and remaining candidate motion sequences based on longitude and latitude coordinates related to the candidate motion sequences. The overlapping degree for a candidate motion sequence may indicate similarity between the candidate motion sequence and the remaining candidate motion sequences. The server may determine a new route between the same departure location and the same destination of the candidate motion sequences based on candidate motion sequences with relatively higher overlapping degrees. In the present disclosure, instead of using map collection vehicles travelling along new roads to collect information related to the new roads, the server determines a new route in a map based on users' movement tracks transmitted from user terminals (e.g., smart phones), which improves the efficiency of determining a new route in a map.

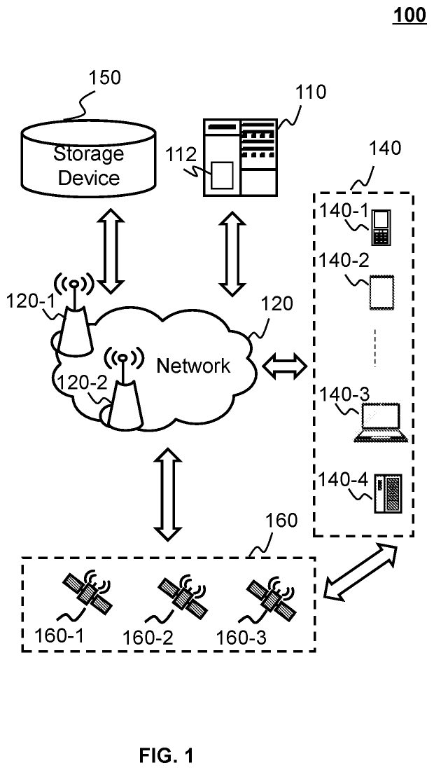

FIG. 1 is a schematic diagram of an exemplary map service system according to some embodiments. The map service system 100 may include a server 110, a network 120, a user terminal 140, a storage device 150, and a positioning system 160.

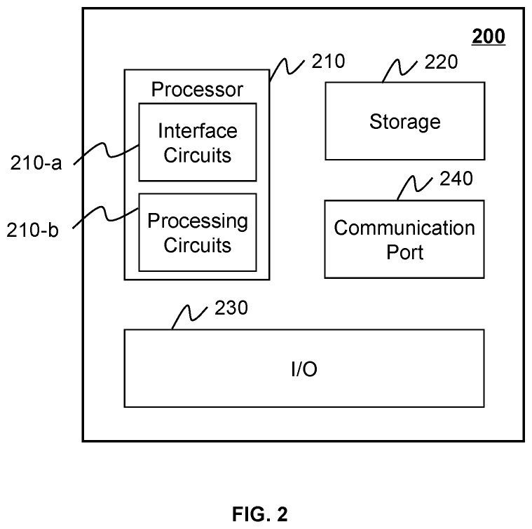

In some embodiments, the server 110 may be a single server or a server group. The server group may be centralized, or distributed (e.g., server 110 may be a distributed system). In some embodiments, the server 110 may be local or remote. For example, the server 110 may access information and/or data stored in the user terminal 140, and/or the storage device 150 via the network 120. As another example, the server 110 may be directly connected to the user terminal 140, and/or the storage device 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data to perform one or more functions described in the present disclosure. For example, the processing engine 112 may determine a new route in a map. In some embodiments, the processing engine 112 may include one or more processing engines (e.g., single-core processing engine(s) or multi-core processor(s)). Merely by way of example, the processing engine 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate the exchange of information and/or data. In some embodiments, one or more components in the map service system 100 (e.g., the server 110, the user terminal 140, the storage device 150, and the positioning system 160) may send information and/or data to other component(s) in the map service system 100 via the network 120. For example, the processing engine 112 may obtain a plurality of original motion sequences from the storage device 150 and/or the user terminal 140 via the network 120. As another example, the processing engine 112 may obtain current route map information corresponding to the plurality of original motion sequences from the storage device 150 via the network 120. In some embodiments, the network 120 may be any type of wired or wireless network, or a combination thereof. Merely by way of example, the network 120 may include a cable network, a wireline network, an optical fiber network, a telecommunications network, an intranet, the Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the map service system 100 may be connected to the network 120 to exchange data and/or information.

In some embodiments, the user terminal 140 may include a mobile device 140-1, a tablet computer 140-2, a laptop computer 140-3, or the like, or any combination thereof. In some embodiments, the mobile device 140-1 may include a smart home device, a wearable device, a mobile equipment, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a bracelet, footgear, glasses, a helmet, a watch, clothing, a backpack, a smart accessory, or the like, or any combination thereof. In some embodiments, the mobile equipment may include a mobile phone, a personal digital assistance (PDA), a gaming device, a navigation device, a point of sale (POS) device, a laptop, a desktop, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google Glass™, a RiftCon™, a Fragments™, a Gear VR™, etc. In some embodiments, the user terminal 140 may be a device with positioning technology for locating the position of the user terminal 140. In some embodiments, the user terminal 140 may send positioning information to the server 110.

The storage device 150 may store data and/or instructions. In some embodiments, the storage device 150 may store data obtained from the user terminal 140 and/or the processing engine 112. For example, the storage device 150 may store a plurality of original motion sequences obtained from the user terminal 140. As another example, the storage device 150 may store one or more candidate motion sequences, one or more effective motion sequences, and a target motion sequence determined by the processing engine 112. In some embodiments, the storage device 150 may store data and/or instructions that the server 110 may execute or use to perform exemplary methods described in the present disclosure. For example, the storage device 150 may store instructions that the processing engine 112 may execute or use to determine a new route in a map. In some embodiments, the storage device 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may be connected to the network 120 to communicate with one or more components in the map service system 100 (e.g., the server 110, the user terminal 140, etc.). One or more components in the map service system 100 may access the data or instructions stored in the storage device 150 via the network 120. In some embodiments, the storage device 150 may be directly connected to or communicate with one or more components in the map service system 100 (e.g., the server 110, the user terminal 140, etc.). In some embodiments, the storage device 150 may be part of the server 110.

The positioning system 160 may determine information associated with an object, for example, the user terminal 140. For example, the positioning system 160 may determine a location of the user terminal 140 in real time. In some embodiments, the positioning system 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, an accumulative mileage number, or a current time. The location may be in the form of coordinates, such as, latitude coordinate and longitude coordinate, etc. The positioning system 160 may include one or more satellites, for example, a satellite 160-1, a satellite 160-2, and a satellite 160-3. The satellites 160-1 through 160-3 may determine the information mentioned above independently or jointly. The satellite positioning system 160 may send the information mentioned above to the network 120, or the user terminal 140 via wireless connections.

FIG. 2 is a schematic diagram illustrating exemplary hardware and/or software components of a computing device on which the processing engine 112 may be implemented according to some embodiments of the present disclosure. As illustrated in FIG. 2, the computing device 200 may include a processor 210, a storage 220, an input/output (I/O) 230, and a communication port 240.

The processor 210 (e.g., logic circuits) may execute computer instructions (e.g., program code) and perform functions of the processing engine 112 in accordance with techniques described herein. For example, the processor 210 may include interface circuits 210-a and processing circuits 210-b therein. The interface circuits may be configured to receive electronic signals from a bus (not shown in FIG. 2), wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus.

The computer instructions may include, for example, routines, programs, objects, components, data structures, procedures, modules, and functions, which perform particular functions described herein. For example, the processor 210 may determine a new route in a map. In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

Merely for illustration, only one processor is described in the computing device 200. However, it should be noted that the computing device 200 in the present disclosure may also include multiple processors, thus operations and/or method steps that are performed by one processor as described in the present disclosure may also be jointly or separately performed by the multiple processors. For example, if in the present disclosure the processor of the computing device 200 executes both step A and step B, it should be understood that step A and step B may also be performed by two or more different processors jointly or separately in the computing device 200 (e.g., a first processor executes step A and a second processor executes step B, or the first and second processors jointly execute steps A and B).

The storage 220 may store data/information obtained from the user terminal 140, the storage device 150, and/or any other component of the map service system 100. In some embodiments, the storage 220 may include a mass storage, a removable storage, a volatile read-and-write memory, a read-only memory (ROM), or the like, or any combination thereof. For example, the mass storage may include a magnetic disk, an optical disk, a solid-state drives, etc. The removable storage may include a flash drive, a floppy disk, an optical disk, a memory card, a zip disk, a magnetic tape, etc. The volatile read-and-write memory may include a random access memory (RAM). The RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. The ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 220 may store one or more programs and/or instructions to perform exemplary methods described in the present disclosure. For example, the storage 220 may store a program for the processing engine 112 for determining a new route in a map.

The I/O 230 may input and/or output signals, data, information, etc. In some embodiments, the I/O 230 may enable a user interaction with the processing engine 112. For example, a user of the map service system 100 may input a predetermined parameter through the I/O 230. In some embodiments, the I/O 230 may include an input device and an output device. Examples of the input device may include a keyboard, a mouse, a touch screen, a microphone, or the like, or a combination thereof. Examples of the output device may include a display device, a loudspeaker, a printer, a projector, or the like, or a combination thereof. Examples of the display device may include a liquid crystal display (LCD), a light-emitting diode (LED)-based display, a flat panel display, a curved screen, a television device, a cathode ray tube (CRT), a touch screen, or the like, or a combination thereof.

The communication port 240 may be connected to a network (e.g., the network 120) to facilitate data communications. The communication port 240 may establish connections between the processing engine 112 and the user terminal 140, the positioning system 160, or the storage device 150. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee link, a mobile network link (e.g., 3G, 4G, 5G, etc.), or the like, or a combination thereof. In some embodiments, the communication port 240 may be and/or include a standardized communication port, such as RS232, RS485, etc.

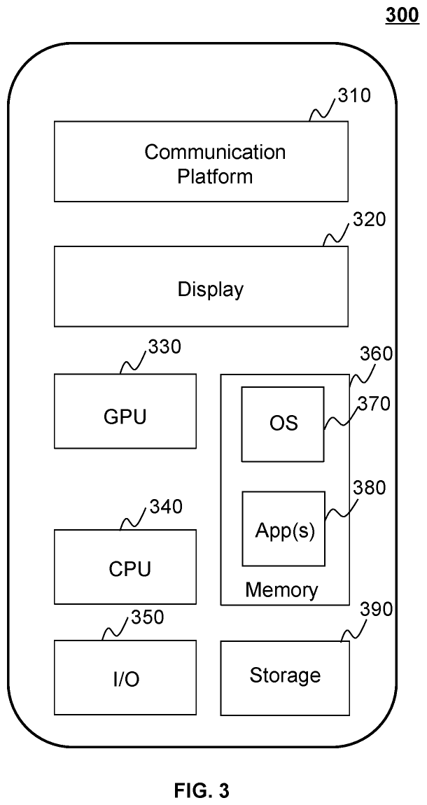

FIG. 3 is a schematic diagram illustrating exemplary hardware and/or software components of a mobile device on which the user terminal 140 may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to image processing or other information from the processing engine 112. User interactions with the information stream may be achieved via the I/O 350 and provided to the processing engine 112 and/or other components of the map service system 100 via the network 120.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

One of ordinary skill in the art would understand that when an element of the map service system 100 performs, the element may perform through electrical signals and/or electromagnetic signals. For example, when the processing engine 112 processes a task, such as making a determination, or transmitting information, the processing engine 112 may operate logic circuits in its processor to process such task. When the processing engine 112 sends out data (e.g., a recommended route) to the user terminal 140, a processor of the processing engine 112 may generate electrical signals encoding the data. The processor of the processing engine 112 may then send the electrical signals to an information exchange port (e.g., an output port) of the processing engine 112. If the user terminal 140 communicates with the processing engine 112 via a wired network, the information exchange port of the processing engine 112 may be physically connected to a cable, which may further transmit the electrical signals to an information exchange port (e.g., an input port) of the user terminal 140. If the user terminal 140 communicates with the processing engine 112 via a wireless network, the information exchange port of the processing engine 112 may be one or more antennas, which may convert the electrical signals to electromagnetic signals. Within an electronic device, such as the user terminal 140, or the server 110, when a processor thereof processes an instruction, sends out an instruction, and/or performs an action, the instruction and/or action is conducted via electrical signals. For example, when the processor retrieves or saves data from a storage medium (e.g., the storage device 150, the storage 220), it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

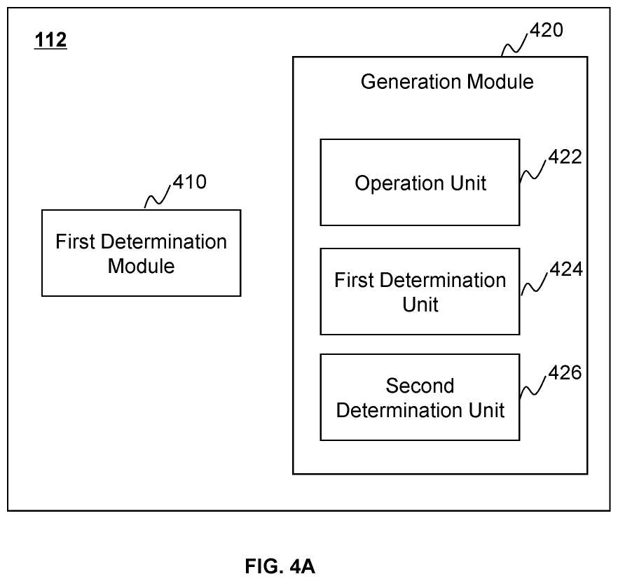

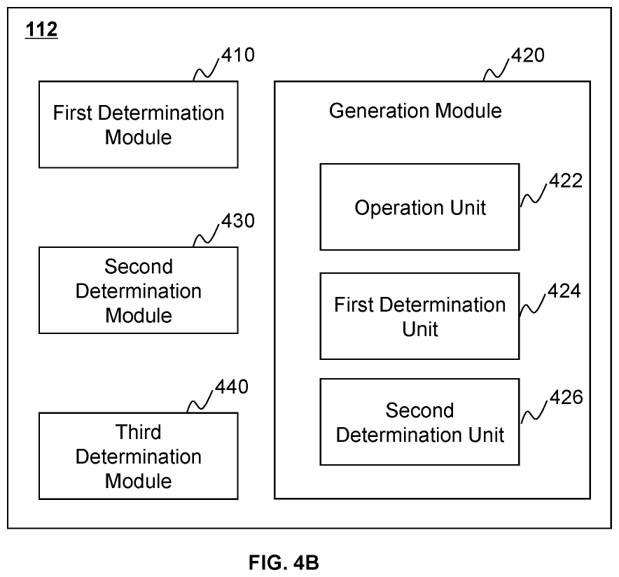

FIG. 4A is a schematic block diagram illustrating an exemplary processing engine according to some embodiments of the present disclosure. The processing engine 112 may include a first determination module 410 and a generation module 420. The generation module 420 may include an operation unit 422, a first determination unit 424, and a second determination unit 426.

The first determination module 410 may be configured to determine a group of candidate motion sequences based on original motion sequences and first route information of current route map information.

In some embodiments, an original motion sequence may represent a movement track of a user. The first determination module 410 may obtain the original motion sequence based on position information acquired by the processing engine 112 from the user terminal 140. The original motion sequence may include a plurality of data points each of which is associated with a position and/or a speed of a user at a time point. The data points in the original motion sequence may be arranged in chronological order. For example, the first data point (also referred to as a departure location) in the original motion sequence may relate to the earliest time point and the last data point (also referred to as a destination) in the original motion sequence may relate to the latest time point. In some embodiments, a user may correspond to multiple original motion sequences. In some embodiments, the position in the present disclosure may be represented by latitude and longitude coordinates, a point of interest (POI) name, or the like, or any combination thereof.

In some embodiments, the group of candidate motion sequences may include one or more candidate motion sequences. The one or more candidate motion sequences in the group of candidate motion sequences may be one or more original motion sequences that have a same departure location and a same destination, and relate to one or more sequence routes different from the first route information of the current route map information.

Merely by way of example, the first determination module 410 may determine the group of candidate motion sequences by performing the following operations. In some embodiments, the original motion sequences related to scenarios of slow moving, such as a traffic jam, parking, and moving without a vehicle, may affect the accuracy for determining a new route. As a result, the first determination module 410 may remove the original motion sequences related to scenarios of slow moving. The first determination module 410 may determine a motion speed corresponding to each original motion sequence. The first determination module 410 may determine the motion speed based on an average value of the speeds of two or more data points in the original motion sequence. Alternatively, the first determination module 410 may determine the motion speed based on a distance and a time interval between any two data points in the original motion sequence. The first determination module 410 may remove the original motion sequences of which the motion speeds are less than or equal to a speed threshold (e.g., 10 km/h, 20 km/h, 30 km/h). The first determination module 410 may determine the original motion sequence of which the motion speed is greater than the speed threshold and the sequence route is different from the first route information as the candidate motion sequence. If there is one candidate motion sequence, the sequence route of the candidate motion sequence may be determined as the new route. If there are multiple candidate motion sequences, the first determination module 410 may divide the candidate motion sequences into one or more groups each of which includes one or more candidate motion sequences having a same departure location and a same destination.

The generation module 420 may be configured to determine a new route based on overlapping degrees corresponding to one or more candidate motion sequences in the group of candidate motion sequences. In some embodiments, the generation module 420 may include an operation unit 422, a first determination unit 424, and a second determination unit 426.

The operation unit 422 may be configured to determine an overlapping degree between each of multiple candidate motion sequences and remaining of the candidate motion sequences in the group of candidate motion sequences.

In some embodiments, for the multiple candidate motion sequences in the group of candidate motion sequences, the operation unit 422 may determine one or more geographic lines (e.g., longitude lines, or latitude lines) that intersect the sequence routes of the candidate motion sequences. Distances between any two adjacent geographic lines may be same or different. Each of the one or more geographic lines has a first geographic coordinate (e.g., a longitude coordinate). The operation unit 422 may determine intersections between the sequence routes of the candidate motion sequences and the one or more geographic lines. The intersection has the first geographic coordinate and a second geographic coordinate (e.g., a latitude coordinate). The operation unit 422 may determine a difference, on each of the one or more geographic lines, between the second geographic coordinates associated with any one of the candidate motion sequences and remaining of the candidate motion sequences (e.g., a difference between the second geographic coordinates of the intersections, on each of the one or more geographic lines, related to the sequence route of any one of the candidate motion sequences and the sequence routes of remaining of the candidate motion sequences). The operation unit 422 may determine, corresponding to the difference of the second geographic coordinates, a matching degree, a sum of which is the overlapping degree. For example, the operation unit 422 may determine a sum of differences each of which is between the second geographic coordinates of two intersections, on one of the one or more geographic lines, related to a first sequence route of a first candidate motion sequence and a second sequence route of a second candidate motion sequence. If the sum of differences is less than or equal to a difference threshold, the operation unit 422 may determine that the matching degree between the first candidate motion sequence and the second candidate motion sequence is equal to 1. If the sum of differences is greater than the difference threshold, the operation unit 422 may determine that the matching degree between the first candidate motion sequence and the second candidate motion sequence is equal to 0.

After determining the matching degrees between each sequence route and the remaining of the sequence routes, the operation unit 422 may designate a sum of the matching degrees between a sequence route and the remaining of the sequence routes as the overlapping degree between the sequence route and the remaining of the sequence routes.

The first determination unit 424 may configured to determine at least one effective motion sequence each of which is one of the multiple of candidate motion sequences having the overlapping degrees larger than or equal to an overlapping threshold (e.g., 0, 1, or 2).

The second determination unit 426 may configured to determine a target motion sequence based on the at least one effective motion sequence, and determine a new route based on the target motion sequence.

In some embodiments, the processing engine 112 may further include a modification module (not shown in FIG. 4A) configured to modify the departure locations and/or the destinations in the original motion sequences.

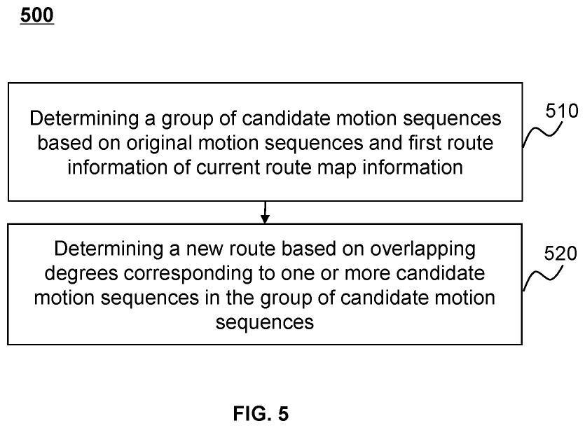

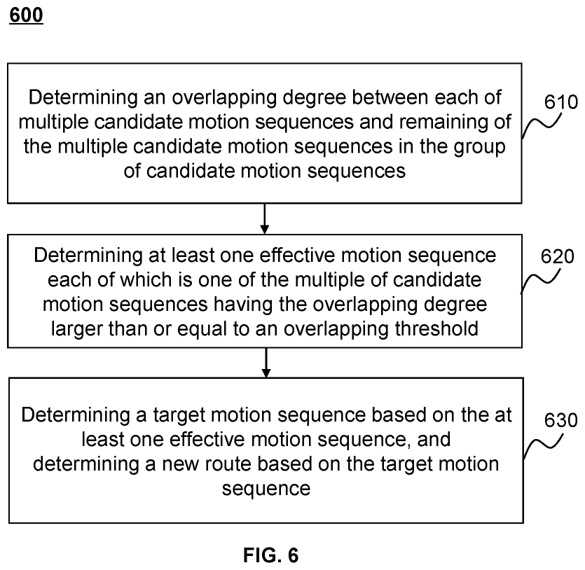

Details regarding the process for determining the new route may be found elsewhere in the present disclosure (e.g., the description in connection with FIG. 5 and/or FIG. 6).

The modules and/or units in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth™, a ZigBee™, a Near Field Communication (NFC), or the like, or any combination thereof. Two or more of the modules may be combined as a single module, and any one of the modules may be divided into two or more units. For example, the first determination module 410 may be divided into two units. The first unit may be configured to obtain a plurality of original motion sequences. The second unit may be configured to determine a group of candidate motion sequences.

It should be noted that the descriptions above in relation to processing engine 112 is provided for the purposes of illustration, and not intended to limit the scope of the present disclosure. For persons having ordinary skills in the art, various variations and modifications may be conducted under the guidance of the present disclosure. However, those variations and modifications do not depart the scope of the present disclosure. In some embodiments, the processing engine 112 may include one or more other modules. For example, the processing engine 112 may include a storage module to store data generated by the modules in the processing engine 112. In some embodiments, any two of the modules may be combined as a single module, and any one of the modules may be divided into two or more units.

FIG. 4B is a schematic block diagram illustrating an exemplary processing engine according to some embodiments of the present disclosure. As shown in FIG. 4B, besides the first determination module 410 and the generation module 420 illustrated in FIG. 4A, the processing engine 112 may further include a second determination module 430 and a third determination module 440.

The second determination module 430 may be configured to determine one or more candidate route names based on the original motion sequences and the current route map information. The candidate route name may be a route name that is manually input by a user and different from any route name included in the first route information of the current route map information. In some embodiments, the second determination module 430 may also determine a location related to each of the one or more candidate route names.

In some embodiments, the second determination module 430 may determine the names, which are manually input by users, of the departure locations and/or the destinations of the original motion sequences as the original route names, because the names manually input by users are possible to be new route names not included in the current route map information. The second determination module 430 may determine the original route name that is different from any route name included in the first route information of the current route map information as the candidate route name.

The third determination module 440 may be configured to determine, from the one or more candidate route names, a target route name corresponding to the new route based on a geographic location associated with the new route, and add second route information including the new route and the target route name to the current route map information.

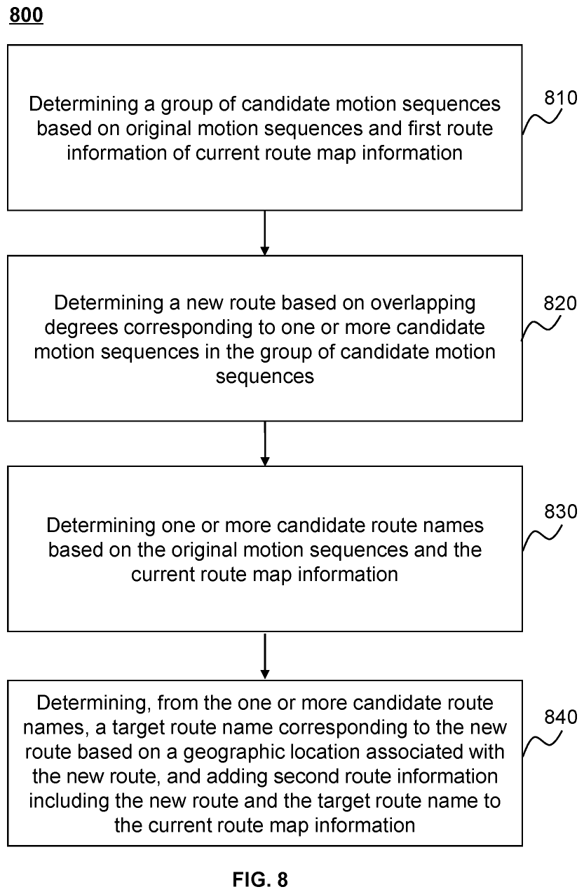

Details regarding the process for determining the new route name may be found elsewhere in the present disclosure (e.g., the description in connection with operations 830-840 in FIG. 8).

The modules and/or units in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth™, a ZigBee™, a Near Field Communication (NFC), or the like, or any combination thereof. Two or more of the modules may be combined as a single module, and any one of the modules may be divided into two or more units. For example, the second determination module 430 may be integrated with the third determination module 440 as a single module which may determine one or more candidate route names and a target route name corresponding to a new route. As another example, the first determination module 410 may be divided into two units. The first unit may be configured to obtain a plurality of original motion sequences. The second unit may be configured to determine a group of candidate motion sequences.

It should be noted that the descriptions above in relation to processing engine 112 is provided for the purposes of illustration, and not intended to limit the scope of the present disclosure. For persons having ordinary skills in the art, various variations and modifications may be conducted under the guidance of the present disclosure. However, those variations and modifications do not depart the scope of the present disclosure. In some embodiments, the processing engine 112 may include one or more other modules. For example, the processing engine 112 may include a storage module to store data generated by the modules in the processing engine 112. In some embodiments, any two of the modules may be combined as a single module, and any one of the modules may be divided into two or more units.

FIG. 5 is a flowchart illustrating an exemplary process for determining a new route in a map according to some embodiments of the present disclosure. In some embodiments, the process 500 may be implemented in the map service system 100 illustrated in FIG. 1. For example, the process 500 may be stored in a storage medium (e.g., the storage device 150, or the storage 220 of the processing engine 112) as a form of instructions, and invoked and/or executed by the server 110 (e.g., the processing engine 112 of the server 110, the processor 220 of the processing engine 112, or one or more modules in the processing engine 112 illustrated in FIG. 4). The operations of the illustrated process 500 presented below are intended to be illustrative. In some embodiments, the process 500 may be accomplished with one or more additional operations not described, and/or without one or more of the operations discussed. Additionally, the order in which the operations of the process 500 as illustrated in FIG. 5 and described below is not intended to be limiting.

In 510, the first determination module 410 (or the processing engine 112, and/or the processing circuits 210-b) may determine a group of candidate motion sequences based on original motion sequences and first route information of current route map information.

In some embodiments, the user terminal 140 may establish a communication (e.g., a wireless communication) with the processing engine 112, via an application installed in the user terminal 140. The application may associate with the map service system 100. For example, the application may be a taxi-hailing application or a navigation application.

The position information (e.g., a real-time position, a time point related to the real-time position, or a speed related to the real-time position) of a user (also the position of the user terminal 140 associated with the user) may be obtained through a positioning technology in the user terminal 140, for example, a GPS, a GLONASS, a COMPASS, a QZSS, a WiFi positioning technology, or the like, or any combination thereof. The application installed in the user terminal 140 may direct the user terminal 140 to constantly or periodically send the position information of the user terminal 140 to the processing engine 112. Consequently, the processing engine 112 may acquire the position information of the user terminal 140 in real-time or substantially real-time. The processing engine 112 may store the position information in a storage medium (e.g., the storage device 150, or the storage 220 of the processing engine 112).

In some embodiments, an original motion sequence may represent a movement track of a user. The first determination module 410 may obtain the original motion sequence based on the position information acquired by the processing engine 112 from the user terminal 140. The original motion sequence may include a plurality of data points each of which is associated with a position and/or a speed of a user at a time point. The data points in the original motion sequence may be arranged in chronological order. For example, the first data point (also referred to as a departure location) in the original motion sequence may relate to the earliest time point and the last data point (also referred to as a destination) in the original motion sequence may relate to the latest time point. In some embodiments, a user may correspond to multiple original motion sequences. In some embodiments, the position in the present disclosure may be represented by latitude and longitude coordinates, a point of interest (P0I) name, or the like, or any combination thereof.

In some embodiments, each original motion sequence may correspond to a sequence route. For example, the sequence route of an original motion sequence may refer to a line passing through the data points in the original motion sequence.

In some embodiments, the original motion sequences may be stored in a storage medium (e.g., the storage device 150, or the storage 220 of the processing engine 112). For example, the original motion sequence may be stored with the identity of the corresponding user as a primary key. As another example, the first data point and the last data point in the original motion sequence may be stored in a first storage medium, and the rest of data points in the original motion sequence may be stored in a second storage medium. In should be noted that the embodiments of the present disclosure do not limit the storing method.

In some embodiments, the current route map information may be stored in a storage medium (e.g., the storage device 150, or the storage 220 of the processing engine 112). The server 110 may use the current route map information to provide location information for a user. For example, the server 110 may recommend a pick-up location for a passenger based on the current route map information in a taxi-hailing service. As another example, the server 110 may recommend a driving route for a driver based on the current route map information in a taxi-hailing service or a navigation service.

In some embodiments, the first route information in the current route map information may include locations and names of a plurality of existing routes included in the current route map information.

In some embodiments, the processing engine 112 may obtain the plurality of original motion sequences and/or the current route map information from a storage medium (e.g., the storage device 150, the storage 220, the user terminal 140, or an external data source (not shown)) via a network (e.g., the network 120).

In some embodiments, the group of candidate motion sequences may include one or more candidate motion sequences. The one or more candidate motion sequences in the group of candidate motion sequences may be one or more original motion sequences that have a same departure location and a same destination, and relate to one or more sequence routes different from the first route information of the current route map information.

Merely by way of example, the first determination module 410 may determine the group of candidate motion sequences by performing the following operations. In some embodiments, the original motion sequences related to scenarios of slow moving, such as a traffic jam, parking, and moving without a vehicle, may affect the accuracy for determining a new route. As a result, the first determination module 410 may remove the original motion sequences related to scenarios of slow moving. The first determination module 410 may determine a motion speed corresponding to each original motion sequence. The first determination module 410 may determine the motion speed based on an average value of the speeds of two or more data points in the original motion sequence. Alternatively, the first determination module 410 may determine the motion speed based on a distance and a time interval between any two data points in the original motion sequence. The first determination module 410 may remove the original motion sequences of which the motion speeds are less than or equal to a speed threshold (e.g., 10 km/h, 20 km/h, 30 km/h). The first determination module 410 may determine the original motion sequence of which the motion speed is greater than the speed threshold and the sequence route is different from the first route information as the candidate motion sequence. If there is one candidate motion sequence, the sequence route of the candidate motion sequence may be determined as the new route. If there are multiple candidate motion sequences, the first determination module 410 may divide the candidate motion sequences into one or more groups each of which includes one or more candidate motion sequences having a same departure location and a same destination. The first determination module 410 may select any one of the one or more groups of candidate motion sequences to perform the process 500 to determine a new route associated with the selected group of candidate motion sequences.

In some embodiments, in order to improve the accuracy of determining the new route, before 510 (e.g., the operation of determining the group of candidate motion sequences based on the original motion sequences and the first route information of the current route map information), the first determination module 410 may modify the departure locations and/or the destinations in the original motion sequences.

Merely by way of example, the departure locations and the destinations in the original motion sequences may be represented by POI names. The first determination module 410 may segment the POI names of the departure locations and the destinations in the original motion sequences. Specifically, the first determination module 410 may segment a POI name into multiple parts. For example, the first determination module 410 may segment a POI name “Community Xixidieyuan, No. 888, Wenyi Road” into three parts, such as “Community Xixidieyuan ______ No. 888______Wenyi Road.” The first determination module 410 may modify the POI name by comparing the segmented POI name with the first route information of the current map information. For example, the first determination module 410 may compare the segmented POI name “Community Xixidieyuan______No. 888______ Wenyi Road” with the first route information. In response to a determination that Community Xixidieyuan is not located on Wenyi Road and there is no No. 888 on Wenyi Road, the first determination module 410 may determine where Community Xixidieyuan is actually located based on the first route information so as to determine a correct POI name. For example, the first determination module 410 may determine that Community Xixidieyuan is located at No. 888, West Wenyi Road based on the first route information. The first determination module 410 may modify the POI name to “Community Xixidieyuan, No. 888, West Wenyi Road” instead of “Community Xixidieyuan, No. 888, Wenyi Road.”

Alternatively or additionally, the process for modifying the departure locations and/or the destinations in the original motion sequences may be performed by a modification module (not shown in FIG. 4A and FIG. 4B) in the processing engine 112.

By modifying the POI names of the departure locations and/or the destinations in the original motion sequences, errors in the POI names of the departure locations and/or the destinations in the original motion sequences may be eliminated and the POI names may be correctly represented. In this way, the accuracy of determining the group of candidate motion sequences and the new route may be improved.

In 520, the generation module 420 (or the processing engine 112, and/or the processing circuits 210-b) may determine a new route based on overlapping degrees corresponding to one or more candidate motion sequences in the group of candidate motion sequences. In some embodiments, the new route may between the same departure location and the same destination of the one or more candidate motion sequences in the group of candidate motion sequences. In some embodiments, if the group of candidate motion sequences include one candidate motion sequence, the generation module 420 may determine the sequence route related to the candidate motion sequence as the new route. Details regarding the process for determining the new route may be found elsewhere in the present disclosure (e.g., the description in connection with FIG. 6).

In some embodiments, if the candidate motion sequences are divided into multiple groups of candidate motion sequences, the processing engine 112 may process the multiple groups of candidate motion sequences one by one or simultaneously to determine a new route related to each of the multiple groups of candidate motion sequences based on the process 500.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 6 is a flowchart illustrating an exemplary process for determining a new route according to some embodiments of the present disclosure. In some embodiments, the process 600 may be implemented in the map service system 100 illustrated in FIG. 1. For example, the process 600 may be stored in a storage medium (e.g., the storage device 150, or the storage 220 of the processing engine 112) as a form of instructions, and invoked and/or executed by the server 110 (e.g., the processing engine 112 of the server 110, the processor 220 of the processing engine 112, or one or more modules in the processing engine 112 illustrated in FIG. 4). The operations of the illustrated process 600 presented below are intended to be illustrative. In some embodiments, the process 600 may be accomplished with one or more additional operations not described, and/or without one or more of the operations discussed. Additionally, the order in which the operations of the process 600 as illustrated in FIG. 6 and described below is not intended to be limiting. In some embodiments, operation 520 illustrated in FIG. 5 may be performed according to the process 600. In some embodiments, if the group of candidate motion sequences include multiple candidate motion sequences, the new route may be generated based on the process 600.

In 610, the generation module 420 (the processing engine 112 and/or the processing circuits 210-b, or the operation unit 422) may determine an overlapping degree between each of multiple candidate motion sequences and remaining of the candidate motion sequences in the group of candidate motion sequences.

In some embodiments, for the multiple candidate motion sequences in the group of candidate motion sequences, the generation module 420 may determine one or more geographic lines (e.g., longitude lines, or latitude lines) that intersect the sequence routes of the candidate motion sequences. Distances between any two adjacent geographic lines may be same or different. Each of the one or more geographic lines has a first geographic coordinate (e.g., a longitude coordinate). The generation module 420 may determine intersections between the sequence routes of the candidate motion sequences and the one or more geographic lines. The intersection has the first geographic coordinate and a second geographic coordinate (e.g., a latitude coordinate). The generation module 420 may determine a difference, on each of the one or more geographic lines, between the second geographic coordinates associated with any one of the candidate motion sequences and remaining of the candidate motion sequences (e.g., a difference between the second geographic coordinates of the intersections, on each of the one or more geographic lines, related to the sequence route of any one of the candidate motion sequences and the sequence routes of remaining of the candidate motion sequences). The generation module 420 may determine, corresponding to the difference of the second geographic coordinates, a matching degree, a sum of which is the overlapping degree. For example, the generation module 420 may determine a sum of differences each of which is between the second geographic coordinates of two intersections, on one of the one or more geographic lines, related to a first sequence route of a first candidate motion sequence and a second sequence route of a second candidate motion sequence. If the sum of differences is less than or equal to a difference threshold, the generation module 420 may determine that the matching degree between the first candidate motion sequence and the second candidate motion sequence is equal to 1. If the sum of differences is greater than the difference threshold, the generation module 420 may determine that the matching degree between the first candidate motion sequence and the second candidate motion sequence is equal to 0.

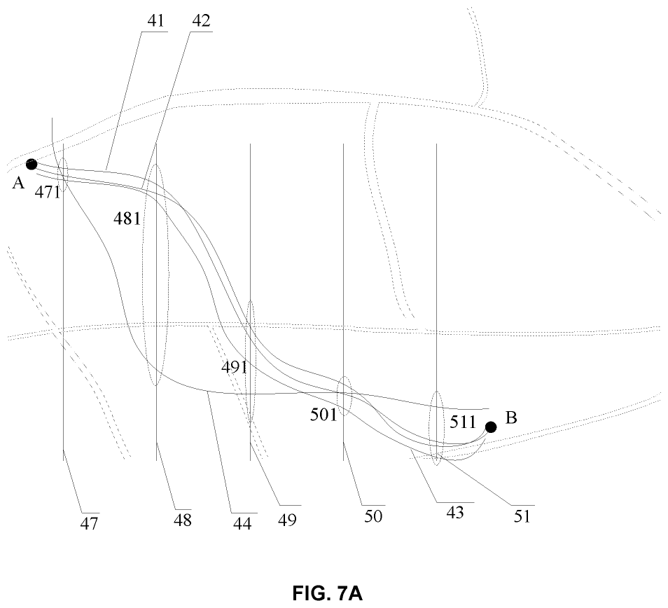

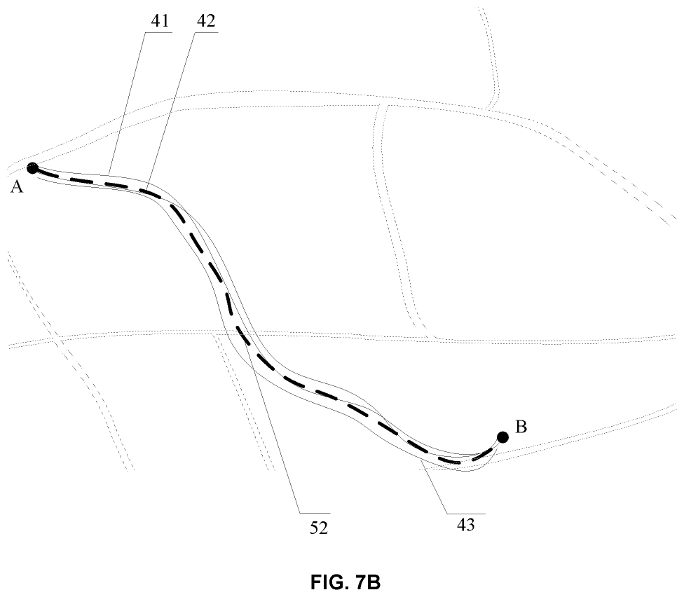

FIG. 7A is a schematic diagram of determining an overlapping degree corresponding to an exemplary candidate motion sequence according to some embodiments of the present disclosure.

As shown in FIG. 7A, a group of candidate motion sequences includes four candidate motion sequences, each of which relates to a sequence route, such as routes 41-44. The four candidate motion sequences in the group of candidate motion sequences may have two same endpoints A and B. The generation module 420 may determine multiple (e.g., 5) longitude lines, such as lines 47-51, for the four candidate motion sequences at a predetermined distance. Each of the 5 longitude lines has a longitude coordinate. As shown in FIG. 7A, 471, 481, 491, 501, and 511 refer to the intersections (e.g., the intersections included in the dashed circles) between the sequence routes of the 4 candidate motion sequences and the 5 longitude lines. For example, 471 refers to intersections between line 47 and routes 41-44, 481 refers to intersections between line 48 and routes 41-44, 491 refers to intersections between line 49 and routes 41-44, 501 refers to intersections between line 50 and routes 41-44, and 511 refers to intersections between line 51 and routes 41-44. Each intersection has a longitude coordinate and a latitude coordinate.

For each sequence route, the generation module 420 may determine differences between the sequence route and remaining of the sequence routes. For example, for route 41, the generation module 420 may determine the differences between route 41 and the remaining of the sequence routes (e.g., route 42, route 43, and route 44), respectively; for route 42, the generation module 420 may determine the differences between route 42 and the remaining of the sequence routes (e.g., route 41, route 43, and route 44), respectively; for route 43, the generation module 420 may determine the differences between route 43 and the remaining of the sequence routes (e.g., route 41, route 42, and route 44), respectively; and for route 44, the generation module 420 may determine the differences between route 44 and the remaining of the sequence routes (e.g., route 41, route 42, and route 43), respectively.

For brevity, the determination of the differences between route 41 and the remaining of the sequence routes (e.g., route 42, route 43, and route 44) may be described as an example. For routes 41 and 42, the generation module 420 may first determine a coordinate difference between the latitude coordinates of two intersections, on each of the 5 longitude lines, related to route 41 and route 42. The generation module 420 may then determine the difference between route 41 and route 42 by determining a sum of the coordinate differences related to the 5 longitude lines. The difference between routes 41 and 43, and the difference between routes 41 and 44 may be determined based on a process similar to the determination of the difference between routes 41 and 42.

After determining the differences between route 41 and the remaining of the sequence routes (e.g., routes 42-44), the generation module 420 may determine matching degrees between route 41 and the remaining of the sequence routes (e.g., routes 42-44). For example, if the difference between route 41 and route 42 is greater than or equal to the difference threshold, the generation module 420 may determine that the matching degree between route 41 and route 42 is equal to 0. If the difference between route 41 and route 42 is less than the difference threshold, the generation module 420 may determine that the matching degree between route 41 and route 42 is equal to 1. Accordingly, the generation module 420 may generate a 4*4 matrix. Each row and each column in the matrix may represent a sequence route, respectively. Each element in the matrix may represent a matching degree between two sequence routes. For example, the element in the second row and third column of the matrix may represent the matching degree between route 42 and route 43.

After determining the matching degrees between each sequence route and the remaining of the sequence routes, the generation module 420 may designate a sum of the matching degrees between a sequence route and the remaining of the sequence routes as the overlapping degree between the sequence route and the remaining of the sequence routes. For example, the matching degree between routes 41 and 42 is 1, the matching degree between routes 41 and 43 is 1, the matching degree between routes 41 and 44 is 0, the matching degree between routes 42 and 43 is 1, the matching degree between routes 42 and 44 is 0, and the matching degree between routes 43 and 44 is 0. The overlapping degree between route 41 and the remaining of the sequence routes (e.g., routes 42-44) is 3, the overlapping degree between route 42 and the remaining of the sequence routes (e.g., route 41, route 43, and route 44) is 3, the overlapping degree between route 43 and the remaining of the sequence routes (e.g., route 41, route 42, and route 44) is 3, and the overlapping degree between route 44 and the remaining of the sequence routes (e.g., routes 41-43) is 0.

In 620, the generation module 420 (the processing engine 112 and/or the processing circuits 210-b, or the first determination unit 424) may determine at least one effective motion sequence each of which is one of the multiple of candidate motion sequences having the overlapping degrees larger than or equal to an overlapping threshold (e.g., 0, 1, or 2).

In some embodiments, the generation module 420 may determine the candidate motion sequence having the largest overlapping degree as the effective motion sequence. Alternatively, the generation module 420 may determine the candidate motion sequence having the overlapping degrees larger than or equal to the overlapping threshold as the effective motion sequence. In some embodiments, the overlapping threshold may be the largest overlapping degree.

FIG. 7B is a schematic diagram of determining effective motion sequences according to some embodiments of the present disclosure. Merely by way of example, the generation module 420 may determine the candidate motion sequence having the largest overlapping degree as the effective motion sequence in FIG. 7B. As a result, as shown in FIG. 7B, the effective motion sequences may include the candidate motion sequences related to routes 41-43 according to the overlapping degrees determined in FIG. 7A.

In 630, the generation module 420 (the processing engine 112 and/or the processing circuits 210-b, or the second determination unit 426) may determine a target motion sequence based on the at least one effective motion sequence, and determine a new route based on the target motion sequence.

In some embodiment, if there is one effective motion sequence, the generation module 420 may determine the effective motion sequence as the target motion sequence.

In some embodiments, if there are multiple effective motion sequences, the generation module 420 may determine the target motion sequence based on the first coordinates and the second coordinates (e.g., the longitude and latitude coordinates) of the intersections between the sequence routes of the effective motion sequences and the one or more geographic lines. For example, according to FIG. 7A, for each longitude line, the generation module 420 may determine an average value of the latitude coordinates of the intersections between the sequence routes (e.g., routes 41-43), which are also the effective motion sequences, and, accordingly, determine a latitude line comprising such an average value, i.e., a point, of the latitude coordinate corresponding to the longitude line. The points may be designate as the target motion sequence by the generation model 420. A line passing through the points would be designated as the sequence route of the target motion sequence by the generation model 420.

Alternatively or additionally, the generation module 420 may locate the data points of the multiple effective motion sequences in a map (e.g., the map illustrated in FIG. 7A and/or FIG. 7B) associated with the current route map information. The generation module 420 may determine a plurality of average positioning points by fitting the data points of the effective motion sequences. In some embodiments, the fitting method may include interpolation, extrapolation, smoothing, regression analysis, the least square method, or the like, or any combination thereof. Exemplary interpolation methods may include Lagrange interpolation, Newton interpolation, Hermite interpolation, piecewise interpolation, spline interpolation, linear interpolation, or the like, or a combination thereof. Exemplary extrapolation methods may include linear extrapolation, polynomial extrapolation, conic extrapolation, French curve extrapolation, or the like, or a combination thereof. Exemplary regression analysis may include linear regression, nonlinear regression, multiple regression, logistic regression, partial regression, or the like, or a combination thereof.

The generation module 420 may designate the plurality of average positioning points, the departure location, and the destination (e.g., points A and B illustrated in FIG. 7A and/or FIG. 7B) of the effective motion sequences as the target motion sequence, and designate a line passing through the plurality of average positioning points, the departure location, and the destination of the effective motion sequences as the sequence route of the target motion sequence.

As shown in FIG. 7B, route 52 (e.g., the dashed line in FIG. 7B) refers to the sequence route of the target motion sequence determined based on the effective motion sequences related to routes 41-43. The generation module 420 may designate route 52 as the new route between locations A and B.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 8 is a flowchart illustrating an exemplary process for determining a target route name according to some embodiments of the present disclosure. In some embodiments, the process 800 may be implemented in the map service system 100 illustrated in FIG. 1. For example, the process 800 may be stored in a storage medium (e.g., the storage device 150, or the storage 220 of the processing engine 112) as a form of instructions, and invoked and/or executed by the server 110 (e.g., the processing engine 112 of the server 110, the processor 220 of the processing engine 112, or one or more modules in the processing engine 112 illustrated in FIG. 4). The operations of the illustrated process 800 presented below are intended to be illustrative. In some embodiments, the process 800 may be accomplished with one or more additional operations not described, and/or without one or more of the operations discussed. Additionally, the order in which the operations of the process 800 as illustrated in FIG. 8 and described below is not intended to be limiting.

In 810, the first determination module 410 (or the processing engine 112, and/or the processing circuits 210-b) may determine a group of candidate motion sequences based on original motion sequences and first route information of current route map information. Details regarding the determination of the group of candidate motion sequences may be found elsewhere in the present disclosure (e.g., the description in connection with operation 510 in FIG. 5).

In 820, the generation module 420 (or the processing engine 112, and/or the processing circuits 210-b) may determine a new route based on overlapping degrees corresponding to one or more candidate motion sequences in the group of candidate motion sequences. Details regarding the determination of the new route may be found elsewhere in the present disclosure (e.g., the description in connection with operation 520 in FIG. 5).

In 830, the second determination module 430 (or the processing engine 112, and/or the processing circuits 210-b) may determine one or more candidate route names based on the original motion sequences and the current route map information. The candidate route name may be a route name that is manually input by a user and different from any route name included in the first route information of the current route map information. In some embodiments, the second determination module 430 may also determine a location related to each of the one or more candidate route names.

In some embodiments, the second determination module 430 may perform 830 before 810, 820, or 840. In some embodiments, the second determination module 430 may perform 830 simultaneously with 810 or 820.

In some embodiments, the second determination module 430 may obtain one or more original route names manually input by users within a predetermined time period (e.g., last one week, last 30 days, or last six months) based on the departure locations and the destinations of the original motion sequences.

In some embodiments, the departure location and/or the destination of the original motion sequence may be a specified location input manually by a user through the user terminal 140 (e.g., the I/O 350 in FIG. 3). In some embodiments, the departure location and/or the destination of the original motion sequence may be obtained by the user terminal 140 through obtaining its location (which is referred to as the location of the user) herein through a positioning technology in the user terminal 140, for example, the GPS, GLONASS, COMPASS, QZSS, BDS, WiFi positioning technology, or the like, or any combination thereof. In some embodiments, the departure location and/or the destination of the original motion sequence may be a specific location selected by a user in a map associated with the current route map information in the user terminal 140. In some embodiments, the departure location and/or the destination of the original motion sequence may be a specific location that is recommended to a user by the server 110 based on the current route map information.

In some embodiments, the second determination module 430 may determine the names, which are manually input by users, of the departure locations and/or the destinations of the original motion sequences as the original route names, because the names manually input by users are possible to be new route names not included in the current route map information. The second determination module 430 may determine the original route name that is different from any route name included in the first route information of the current route map information as the candidate route name.

For example, a new road, named Xinhua Road, has been built near user A's home, but the name of the new road has not been included in the current route map information associated with the map service system 100. When user A uses an taxi-hailing application associated with the current route map information to request a taxi in order to return home from his/her company, user A may manually input “No. 01Xinhua Road” as the destination. In the process of traveling from user A's company to user A's home in a taxi, an original motion sequence with the destination “No. 01, Xinhua Road” is generated. The name “Xinhua Road” may be designated as an original route name. Because the name “Xinhua Road” is different from the first route information of the current route map information, the name “Xinhua Road” may be further designated as a candidate route name.

In 840, the third determination module 440 (or the processing engine 112, and/or the processing circuits 210-b) may determine, from the one or more candidate route names, a target route name corresponding to the new route based on a geographic location associated with the new route, and add second route information including the new route and the target route name to the current route map information.

In some embodiments, the third determination module 440 may determine a matching degree between the new route and each candidate route name based on the geographic location associated with the new route. In some embodiments, if a candidate route name corresponding to a plurality of geographic locations, the third determination module 440 may determine a ratio of a sum of the distances between the plurality of geographical locations corresponding to the candidate route name and the new route to the number of the plurality of geographical locations corresponding to the candidate route name. For example, the third determination module 440 may determine the distance between the new route and each of the plurality of geographic locations corresponding to the candidate route name by determining a distance between center points of the new route and each of the plurality of geographic locations corresponding to the candidate route name.

If the ratio is greater than a ratio threshold, the third determination module 440 may determine that the matching degree between the new route and the candidate route name is equal to 0. If the ratio is less than or equal to the ratio threshold, the third determination module 440 may determine that the matching degree between the new route and the candidate route name is equal to 1.

In some embodiments, if a candidate route name is the name of one geographic location, the third determination module 440 may determine a distance between the new route and the geographic location. If the distance between the new route and the geographic location is greater than a distance threshold, the third determination module 440 may determine that the matching degree between the new route and the candidate route name is equal to 0. If the distance between the new route and the geographic location corresponding to the candidate route name is less than or equal to the distance threshold, the third determination module 440 may determine that the matching degree between the new route and the candidate route name is equal to 1.

In some embodiments, if there is only one candidate route name with the matching degree of 1, the third determination module 440 may determine this candidate route name as the target route name corresponding to the new route. If there are N (N is an integer greater than 1) candidate route names with the matching degree of 1, the third determination module 440 may determine that a probability of being the target route name for the new route for each of the N candidate route names is 1/N. In some embodiments, the third determination module 440 may select any one of the N candidate route names as the target route name corresponding to the new route. In some embodiments, the third determination module 440 may display the N candidate route names (e.g., through the I/O 230). A technician of the server 110 may select one of the displayed N candidate route names. The third determination module 440 may determine the target route name for the new route based on the technician's selection.

After the target route name and the new route are determined, the processing engine 112 may add the second route information including the new route and the target route name to the current route map information to update the current route map information. With the updated current route map information, the map service system 100 may provide more accurate location information to users.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python, or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for determining a new route in a map, comprising:
at least one storage device including a set of instructions;
at least one processor in communication with the at least one storage device, wherein when executing the set of instructions, the at least one processor is directed to cause the system to:
obtain a plurality of original motion sequences, each of the plurality of original motion sequences including a departure location and a destination;
obtain current route map information corresponding to the plurality of original motion sequences;
determine, from the plurality of original motion sequences, one or more candidate motion sequences, which have a same departure location and a same destination but being different from the current route map information; and
determine a new route between the same departure location and the same destination based on the one or more candidate motion sequences.

2. The system of claim 1, wherein if the one or more candidate motion sequences are a multiple of candidate motion sequences, to determine the new route between the same departure location and the same destination based on the one or more candidate motion sequences, the at least one processor is directed to cause the system to:
for each of the multiple of candidate motion sequences, determine an overlapping degree between the each of the multiple of candidate motion sequences and remaining of the multiple of candidate motion sequences;
determine, as an effective motion sequence, any one of the multiple of candidate motion sequences having the overlapping degree larger than or equal to an overlapping threshold; and
determine the new route between the same departure location and same destination based on the effective motion sequence.

3. The system of claim 2, wherein if there are a multiple of effective motion sequences, to determine the new route between the same departure location and the same destination based on the one or more candidate motion sequences, the at least one processor is directed to cause the system to:
determine a target motion sequence based on the multiple of effective motion sequences; and
determine the new route between the same departure location and same destination based on the target motion sequence.

4. The system of claim 2, wherein to determine, for each of the multiple of candidate motion sequences, the overlapping degree between the each of multiple of candidate motion sequences and the remaining of the multiple of candidate motion sequences, the at least one processor is directed to cause the system to:
determine one or more geographic lines, corresponding to the multiple of candidate motion sequences, wherein each of the one or more geographic lines has a first geographic coordinate;
determine intersections between the multiple of candidate motion sequences and the one or more first geographic lines, wherein each of the intersections has the first geographic coordinate and a second geographic coordinate;
for each of the multiple of candidate motion sequences,
determine a difference, on each of the one or more geographic lines, between the second geographic coordinates of the candidate motion sequence and each of the remaining of the multiple of candidate motion sequences; and
determine, corresponding to the difference, a matching degree between the candidate motion sequence and each of the remaining of the multiple of candidate motion sequences, wherein a sum of the one or more matching degrees is the overlapping degree between the candidate motion sequence and the remaining of the multiple of candidate motion sequences.

5. The system of claim 4, wherein to determine, for each of the multiple of candidate motion sequences, the overlapping degree between the each of multiple of candidate motion sequences and the remaining of the multiple of candidate motion sequences, the at least one processor is further directed to cause the system to:
designate the matching degree as 1 in response to the difference equal to or less than a difference threshold, otherwise as 0.

6. The system of claim 1, wherein a speed relating to each of the one or more candidate motion sequences is greater than a speed threshold.

7. The system of claim 1, wherein when executing the set of instructions, the at least one processor is further directed to cause the system to:
correct an address corresponding to the departure locations and/or the destinations before the one or more candidate motion sequences are determined.

8. The system of claim 1, wherein when executing the set of instructions, the at least one processor is further directed to cause the system to:
obtain one or more original route names;
determine one or more candidate route names from the one or more original route names, wherein the one or more candidate route names are different from any route name included in the current route map information;
determine a target route name for the new route from the one or more candidate route names; and
add the target route name to the current route map information.

9. The system of claim 1, wherein each of the plurality of original motion sequences includes data points each of which is associated with a location of a user at a time point.

10. The system of claim 1, wherein the current route map information includes locations and names of a plurality of routes in a map.

11. A method for determining a new route in a map implemented on a computing device having at least one storage device and at least one processor, the method comprising:
obtaining a plurality of original motion sequences, each of the plurality of original motion sequences including a departure location and a destination;
obtaining current route map information corresponding to the plurality of original motion sequences;
determining, from the plurality of original motion sequences, one or more candidate motion sequences, which have a same departure location and a same destination but being different from the current route map information; and
determining a new route between the same departure location and the same destination based on the one or more candidate motion sequences.

12. The method of claim 11, wherein if the one or more candidate motion sequences are a multiple of candidate motion sequences, the determining of the new route between the same departure location and the same destination based on the one or more candidate motion sequences includes:
for each of the multiple of candidate motion sequences, determining an overlapping degree between the each of the multiple of candidate motion sequences and remaining of the multiple of candidate motion sequences;
determining, as an effective motion sequence, any one of the multiple of candidate motion sequences having the overlapping degree larger than or equal to an overlapping threshold; and
determining the new route between the same departure location and same destination based on the effective motion sequence.

13. The method of claim 12, wherein if there are a multiple of effective motion sequences, the determining of the new route between the same departure location and the same destination based on the one or more candidate motion sequences includes:
determining a target motion sequence based on the multiple of effective motion sequences; and
determining the new route between the same departure location and same destination based on the target motion sequence.

14. The method of claim 12, wherein for each of the multiple of candidate motion sequences, the determining of the overlapping degree between the each of multiple of candidate motion sequences and the remaining of the multiple of candidate motion sequences includes:
determining one or more geographic lines, corresponding to the multiple of candidate motion sequences, wherein each of the one or more geographic lines has a first geographic coordinate;
determining intersections between the multiple of candidate motion sequences and the one or more first geographic lines, wherein each of the intersections has the first geographic coordinate and a second geographic coordinate;
for each of the multiple of candidate motion sequences,
determining a difference, on each of the one or more geographic lines, between the second geographic coordinates of the candidate motion sequence and each of the remaining of the multiple of candidate motion sequences; and
determining, corresponding to the difference, a matching degree between the candidate motion sequence and each of the remaining of the multiple of candidate motion sequences, wherein a sum of the one or more matching degrees is the overlapping degree between the candidate motion sequence and the remaining of the multiple of candidate motion sequences.

15. The method of claim 14, wherein for each of the multiple of candidate motion sequences, the determining of the overlapping degree between the each of multiple of candidate motion sequences and the remaining of the multiple of candidate motion sequences further includes:
designating the matching degree as 1 in response to the difference equal to or less than a difference threshold, otherwise as 0.

16. The method of claim 11, wherein a speed relating to each of the one or more candidate motion sequences is greater than a speed threshold.

17. The method of claim 11, the method further comprising:
correcting an address corresponding to the departure locations and/or the destinations before the one or more candidate motion sequences are determined.

18. The method of claim 11, the method further comprising:
obtaining one or more original route names;
determining one or more candidate route names from the one or more original route names, wherein the one or more candidate route names are different from any route name included in the current route map information;
determining a target route name for the new route from the one or more candidate route names; and
adding the target route name to the current route map information.

19. The method of claim 11, wherein
each of the plurality of original motion sequences includes data points each of which is associated with a location of a user at a time point; or
the current route map information includes locations and names of a plurality of routes in a map.

20-30. (canceled)

31. A non-transitory computer readable medium, comprising at least one set of instructions for determining a new route in a map, wherein when executed by one or more processors of a computing device, the at least one set of instructions causes the computing device to perform a method, the method comprising:
obtaining a plurality of original motion sequences, each of the plurality of original motion sequences including a departure location and a destination;
obtaining current route map information corresponding to the plurality of original motion sequences;
determining, from the plurality of original motion sequences, one or more candidate motion sequences, which have a same departure location and a same destination but being different from the current route map information; and
determining a new route between the same departure location and the same destination based on the one or more candidate motion sequences.
